(19) United States
(12) Patent Application Publication
(10) Pub. No.: US 2016/0063427 A1
(43) Pub. Date: Mar. 3, 2016

(54) CREDIT ATTRIBUTION BASED ON MEASURED CONTRIBUTIONS OF MARKETING ACTIVITIES TO DEALS

(71) Applicant: Linkedln Corporation, Mountain View, CA (US)

(72) Inventors: Ying Xu, San Jose, CA (US); Brion O'Connor, San Jose, CA (US); Brent Teraoka, San Jose, CA (US)

(21) Appl. No.: 14/473,039

(22) Filed: Aug. 29, 2014

(51) Int. Cl. G06Q 10/06

(52) U.S. Cl. CPC G06Q 10/06398

(57) ABSTRACT

A machine may be configured to attribute credit for a deal among items of marketing output that contributed to the deal. For example, the machine accesses deal data that describes a deal for a product or service between a provider and an entity to receive the product or service. The machine maps a deal identifier to a marketing campaign identifier based on the deal data. A marketing campaign may include items of marketing output that promote the product or service during marketing touches of the marketing campaign by one or more representatives of the entity. The machine identifies a time of a particular marketing touch and a marketing channel used to present an item of marketing output during the particular marketing touch. The machine computes a share of credit, for the deal based on the time and the marketing channel, that is attributable to the item of marketing output.

### TECHNICAL FIELD

The present application relates generally to the processing of data, and, in various example embodiments, to systems, methods, and computer program products for measuring contributions of marketing activities or items of marketing content to a deal, and for determining an attribution of credit for the deal based on the measured contributions of the marketing activities or items of marketing content to the deal.

### BACKGROUND

Traditionally, businesses allocate credit for a sale to a member of a sales team. One reason for the allocation of the credit for the sale to a salesperson is to acknowledge the effort made in converting a lead (e.g., an opportunity for a transaction or deal) into a closed deal. However, this approach of allocating credit for the sale solely to a salesperson may not properly account for the contribution of one or more marketing professionals in creating marketing materials and organizing marketing activities used in promoting the sold product or service.

In some instances, when a business does allocate some credit to a marketing organization for its contributions to the closing of a deal, the allocation of credit for the sale of a product or service is based on the “last touch” model. Under the “last touch” model, the last marketing channel (or item of content, or marketing activity) with which a user interacted before purchasing the product or service is attributed the credit for the particular sale based on the assumption that the information from the last marketing channel influenced the closing of the deal. In other instances, the credit for the closed deal is attributed to a first marketing channel with which the user interacted. However, often, neither the “first touch” model nor the “last touch” model indicate a correct attribution of credit to the sources that contributed to the closed deal.

### BRIEF DESCRIPTION OF THE DRAWINGS

Some embodiments are illustrated by way of example and not limitation in the figures of the accompanying drawings, in which:

FIG. 1 is a network diagram illustrating a client-server system, according to some example embodiments;

FIG. 2 is a diagram illustrating an attribution of credit for a deal among items of marketing output that contributed to the deal, according to some example embodiments;

FIG. 3 is a block diagram illustrating components of an attribution system, according to some example embodiments;

FIG. 4 is a flowchart illustrating a method of attributing credit for a deal among items of marketing output that contributed to the deal, according to some example embodiments;

FIG. 5 is a flowchart that illustrates a method of attributing credit for a deal among items of marketing output that contributed to the deal and represents the step 420 of FIG. 4 in more detail, according to some example embodiments;

FIG. 6 is a flowchart that illustrates a method of attributing credit for a deal among items of marketing output that contributed to the deal and represents the step 420 of FIG. 4 in more detail, according to some example embodiments;

FIG. 7 is a flowchart that illustrates a method of attributing credit for a deal among items of marketing output that contributed to the deal and represents one or more additional steps of FIG. 4, according to some example embodiments;

FIG. 8 is a flowchart that illustrates a method of attributing credit for a deal among items of marketing output that contributed to the deal and represents the step 450 of FIG. 4 in more detail, according to some example embodiments;

FIG. 9 is a flowchart that illustrates a method of attributing credit for a deal among items of marketing output that contributed to the deal and represents the step 450 of FIG. 4 in more detail, according to some example embodiments;

FIG. 10 is a flowchart that illustrates a method of attributing credit for a deal among items of marketing output that contributed to the deal and represents one or more additional steps of FIG. 4, according to some example embodiments;

FIG. 11 is a flowchart that illustrates a method of attributing credit for a deal among items of marketing output that contributed to the deal and represents one or more additional steps of FIG. 4, according to some example embodiments;

FIG. 12 is a block diagram illustrating a mobile device, according to some example embodiments; and

FIG. 13 is a block diagram illustrating components of a machine, according to some example embodiments, able to read instructions from a machine-readable medium and perform any one or more of the methodologies discussed herein.

### DETAILED DESCRIPTION

Example methods and systems for measuring contributions of marketing activities or items of marketing content to a deal, and for determining an attribution of credit for the deal based on the measured contributions of the marketing activities or items of marketing content to the deal are described. In the following description, for purposes of explanation, numerous specific details are set forth to provide a thorough understanding of example embodiments. It will be evident to one skilled in the art, however, that the present subject matter may be practiced without these specific details. Furthermore, unless explicitly stated otherwise, components and functions are optional and may be combined or subdivided, and operations may vary in sequence or be combined or subdivided.

In the business-to-business (also “B2B”) context, employees of an organization (e.g., a business entity, also an “entity”) may gather information about a product or service before purchasing the product or service for the organization. Information about the product or service may be generated by a marketing department of the provider of the product or service as part of one or more marketing campaigns in order to promote the product or service to potential buyers or subscribers. The information that promotes the product or service may be disseminated to potential customers via a number of marketing channels, both online and offline, and employing a variety of items of marketing content or marketing activities.

In some instances, the marketing output that promote a product or service not only educate potential customers about the features or benefits of the product or service but also serve as touchpoints of a particular marketing campaign. According to various example embodiments, the marketing output is the totality of marketing activities, marketing products, marketing content, etc. that promote a product or service and that are created by a marketing group (e.g., a marketing organization or department within the company that sells the product or service) to facilitate the selling of the product or service.

A touchpoint (also “touch”) may be an identifier of an interaction by a user (e.g., a potential buyer, a representative of a potential customer such as an employee of an organization, etc.) with an item of marketing output, such as an item of marketing content or a marketing activity associated with a marketing campaign. Examples of online touches with a marketing campaign are an online user registering to attend a web seminar (also “webinar”), an online user requesting content that pertains to a product or service, or an online user requesting to contact or to be contacted by a representative of the provider of the product or service. An example of an offline touch with a marketing campaign is a user registering to attend an offline (e.g., a physical, real-world) event, such as a conference organized to present or promote a product or service.

In some example embodiments, a user providing contact information during a marketing touch (e.g., by filling out a contact information form or registering for an event) signals an increased level of interest of the user in the product or service. Marketing touches by the user that are not associated with a receipt of contact information from the user may not be indicative of a heightened interest in the product or service on the part of the user.

In some example embodiments, an attribution system may track (e.g., identify, detect, or collect or gather data about) marketing touches that pertain to a marketing campaign. For example, the attribution system may detect interactions by one or more users with one or more items of marketing output of a marketing campaign. The data that pertains to marketing touches may be collected from one or more systems that facilitate the interactions of users with various items of marketing output. In some instances, the attribution system consolidates (e.g., aggregates, standardizes, normalizes, etc.) the data that pertains to marketing touches to allow for the analysis of such data.

The attribution system may also determine that the one or more users are associated with (e.g., are representatives of) a particular entity (e.g., a company, an organization, a business, etc.). The particular entity may be represented by an account identifier in one or more records of a database associated with the attribution system. The particular entity may be regarded as a potential purchaser of a product or service offered for sale or subscription by a provider of the product or service. The gathering of information regarding touches of the marketing campaign by the representatives of the entity may allow the attribution system to analyze the information regarding the touches and to measure the influence of the particular items of marketing output communicated during the touches on the purchase process associated with a particular closed deal.

According to certain example embodiments, the attribution system performs an analysis of the data that pertains to particular marketing touches by one or more representatives of an organization. The attribution system may measure the level of contribution (e.g., the influence) of the items of marketing content or marketing activities associated with the particular marketing touches to the closing of a deal with the organization. In some instances, only data that pertains to marketing touches associated with a heightened interest in the product or service is analyzed. In certain instances, the type of channel used to present items of marketing output during marketing touches or the recency of the marketing touches, or both, may be factors utilized in the analysis of the marketing touches for purposes of determining the contribution of certain marketing output to the closing of a deal.

The attribution system may determine an attribution of credit for the deal to the one or more items of marketing output based on the measured contributions of the one or more items of marketing output to the deal. In some instances, the attribution system may allocate credit for a particular percentage value of the bookings resulting from the sale of the product or service to the purchasing entity based on the individual level of contribution of the items of marketing output to the deal.

In some example embodiments, the attribution system may compute a contribution share to a deal by a particular item of marketing output presented to a user (e.g., a representative of a purchaser) during a particular marketing touch using the following formula:

$$Wt ( x ) = \frac{1 - \frac{( {W}_{x} ) ( {T}_{x} )}{{\sum }_{i = 1}^{n} ( {W}_{i} ) ( {T}_{i} )}}{( N - 1 )}$$

where x indicates the particular marketing touch; Wt(x) corresponds to the contribution share to the deal by a particular item of marketing output presented during the particular marketing touch x; T is a recency value associated with a particular touch, that indicates the time between the time of occurrence of the particular touch and the time of closing the deal; W is a weight value assigned to the recency value associated with the particular touch; N is the number of touches preceding the closing of the deal. In certain example embodiments, the weight W corresponds to a conversion value pertaining to a type of channel used to present marketing output during a marketing touch. Examples of B2B marketing channels are “request content” (e.g., online), “request contact” (e.g., online), “web seminar” (e.g., online), and offline event (e.g., offline).

In some example embodiments, an opportunity to sell a product or service may be opened when a representative of a business entity touches a marketing campaign (e.g., interacts with an item of marketing output of the marketing campaign) for the first time. The opportunity may close when a deal between the provider of the product or service and the entity (or an agent or representative of the entity) is closed (e.g., entered into). The opportunity may be associated with a number of marketing touches that precede the date of the closing of the deal and with the deal itself. Identifiers (e.g., alphanumeric IDs) of the deal, opportunity, and marketing touches may be stored as deal data in one or more records of a database associated with the attribution system.

For example, a particular deal may be associated with three touches.

TABLE 1
Example three-touch deal

| | Touch 1 | Touch 2 | Touch 3 |
|---|---|---|---|
| Date of Touch | Jan. 1, 2013 | Jan. 15, 2013 | Jan. 25, 2013 |
| Type of Channel | Request Contact | Event | Request Contact |
| Tx (days) | 30 | 15 | 5 |

Opportunity Close Date: Jan. 30, 2013

As shown in Table 1 above, Touch 1 occurred on Jan. 1, 2013. Touch 1 may be an identifier of an interaction by a first representative of the entity with an item of marketing output communicated through the Request Contact channel thirty days before the Opportunity Close Date. Touch 2 occurred on Jan. 15, 2013. Touch 2may be an identifier of an interaction by the first representative or a different representative of the entity with an item of marketing output communicated through the Event channel fifteen days before the Opportunity Close Date. Touch 3 occurred on Jan. 25, 2013. Touch 3may be an identifier of an interaction by the first representative or a different representative of the entity with an item of marketing output communicated through the Request Contact channel five days before the Opportunity Close Date.

TABLE 2
Weight that pertains to a type of channel

| | Request Contact | Request Content | Webcast | Event |
|---|---|---|---|---|
| Wx | 10% | 8% | 20% | 13% |

As shown in Table 2 above, different marketing channels may be associated with different weights. In some example embodiments, the weight associated with a marketing channel corresponds to a conversion rate for the marketing channel. The conversion rate for a particular marketing channel may be computed as the ratio of the number of deals where the particular channel was used to the sum of the number of deals where the particular channel was used and the number of failed deals where the particular channel was used.

Using the example data shown in Table 1 and Table 2, the attribution system may compute the contribution to the deal by the items of marketing output presented during the three marketing touches based on the times the particular marketing touches occurred and the types of marketing channels used during the particular marketing touches. Accordingly, for Touch 1,

Wt(x)=(1−((0.10×30)/((0.10×30)+(0.13×15)+(0.10×5))/(3−1)=22.48%.

### For Touch 2,

Wt(x)=(1−((0.13×15)/((0.10×30)+(0.13×15)+(0.10×5))/(3−1)=32.11%.

### For Touch 3,

Wt(x)=(1−((0.10×5)/((0.10×30)+(0.13×15)+(0.10×5))/(3−1)=45.41%.

Thus, the shares of credit for the deal that are attributable to the Touch 1, Touch, 2, and Touch 3 are 22.48%, 32.11%, and 45.41%, respectively.

The attribution system may also identify a booking amount associated with the deal and may determine an attribution of the booking amount among the marketing touches based on their respective share of credit for the deal. For example, if the booking amount for the three-touch deal described above is $1000, then the attribution system may attribute $224.80 of the booking amount to Touch 1, $321.10 of the booking amount to Touch 2, and $454.10 of the booking amount to Touch 3.

In some example embodiments, the weight value corresponds to a level of influence of the marketing campaign rather than the marketing channel. In some instances, the weight value is determined by the ratio of the number of deals associated with a particular campaign (regardless of the sequence of touches) to the sum of the number of deals associated with the particular campaign and the number of failed deals associated with the particular campaign (regardless of the sequence of touches). In certain instances, the weight value is determined by the ratio of the number of deals associated with a particular campaign (where the campaign shows up in the last touch of a sequence of touches) to the sum of the number of deals associated with the particular campaign and the number of failed deals associated with the particular campaign (regardless of the sequence of touches).

In some example embodiments, a smoothing operation may be applied to a plurality of weight values corresponding to a marketing campaign. The smoothing operation may include computing of an average weight value corresponding to a marketing campaign based on a plurality of weight values corresponding to the marketing campaign, as determined using one or more methods described above. The average weight value corresponding to the marketing campaign may be used in determining the contribution share of the marketing campaign to the deal.

According to some example embodiments, the attribution system may determine a potential distribution of a marketing budget based on the contribution shares of various items of marketing output to one or more deals. For example, the attribution system may identify a budget number that corresponds to a budget amount for a marketing organization. The attribution system may identify a first relationship between a first item of marketing output and a potential item of marketing output based on a description of the potential item of marketing output. The attribution system may identify a second relationship between a second item of marketing output and an additional potential item of marketing output based on a description of the additional potential item of marketing output. The attribution system may determine an allocation of the budget amount between the potential item of marketing output and the additional potential item of marketing output based on the budget number, a first share of credit that corresponds to a contribution by the first item of marketing output to the closing of the deal, and a second share of credit that corresponds to a contribution by the second item of marketing output to the closing of the deal. The attribution system may also generate a recommendation that includes the allocation of the budget amount and may transmit the recommendation to a person responsible for the allocation of the marketing budget.

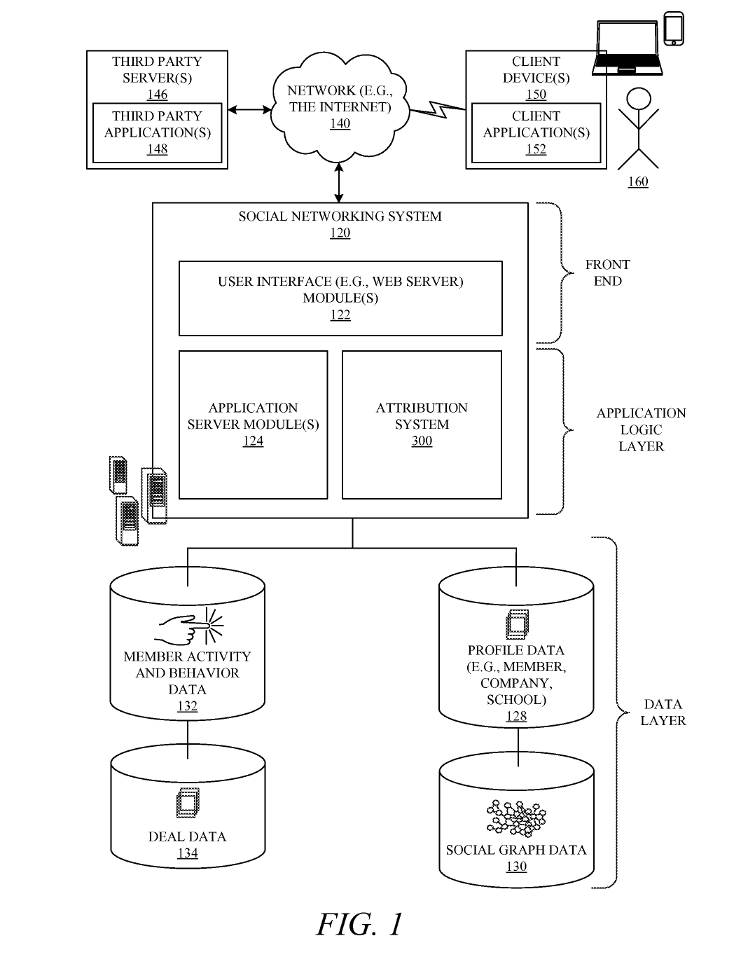

An example method and system for measuring contributions of marketing activities or items of marketing content to a deal, and for determining an attribution of credit for the deal based on the measured contributions of the marketing activities or items of marketing content to the deal may be implemented in the context of the client-server system illustrated in FIG. 1. As illustrated in FIG. 1, the attribution system 300 is part of the social networking system 120. As shown in FIG. 1, the social networking system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, a skilled artisan will readily recognize that various additional functional modules and engines may be used with a social networking system, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the inventive subject matter is by no means limited to such architecture.

As shown in FIG. 1, the front end layer consists of a user interface module(s) (e.g., a web server) 122, which receives requests from various client-computing devices including one or more client device(s) 150, and communicates appropriate responses to the requesting device. For example, the user interface module(s) 122 may receive requests in the form of Hypertext Transport Protocol (HTTP) requests, or other web-based, application programming interface (API) requests. The client device(s) 150 may be executing conventional web browser applications and/or applications (also referred to as “apps”) that have been developed for a specific platform to include any of a wide variety of mobile computing devices and mobile-specific operating systems (e.g., iOS™, Android™, Windows® Phone).

For example, client device(s) 150 may be executing client application(s) 152. The client application(s) 152 may provide functionality to present information to a user and communicate via the network 140 to exchange information with the social networking system 120. Each of the client devices 150 may comprise a computing device that includes at least a display and communication capabilities with the network 140 to access the social networking system 120. The client devices 150 may comprise, but are not limited to, remote devices, work stations, computers, general purpose computers, Internet appliances, hand-held devices, wireless devices, portable devices, wearable computers, cellular or mobile phones, personal digital assistants (PDAs), smart phones, tablets, ultrabooks, netbooks, laptops, desktops, multi-processor systems, microprocessor-based or programmable consumer electronics, game consoles, set-top boxes, network PCs, mini-computers, and the like. One or more users 160 may be a person, a machine, or other means of interacting with the client device(s) 150. The user(s) 160 may interact with the social networking system 120 via the client device(s) 150. The user(s) 160 may not be part of the networked environment, but may be associated with client device(s) 150.

As shown in FIG. 1, the data layer includes several databases, including a database 128 for storing data for various entities of a social graph. In some example embodiments, a “social graph” is a mechanism used by an online social network service (e.g., provided by the social networking system 120) for defining and memorializing, in a digital format, relationships between different entities (e.g., people, employers, educational institutions, organizations, groups, etc.). Frequently, a social graph is a digital representation of real-world relationships. Social graphs may be digital representations of online communities to which a user belongs, often including the members of such communities (e.g., a family, a group of friends, alums of a university, employees of a company, members of a professional association, etc.). The data for various entities of the social graph may include member profiles, company profiles, educational institution profiles, as well as information concerning various online or offline groups. Of course, with various alternative embodiments, any number of other entities may be included in the social graph, and as such, various other databases may be used to store data corresponding to other entities.

Consistent with some embodiments, when a person initially registers to become a member of the social networking service, the person is prompted to provide some personal information, such as the person's name, age (e.g., birth date), gender, interests, contact information, home town, address, the names of the member's spouse and/or family members, educational background (e.g., schools, majors, etc.), current job title, job description, industry, employment history, skills, professional organizations, interests, and so on. This information is stored, for example, as profile data in the database 128.

Once registered, a member may invite other members, or be invited by other members, to connect via the social networking service. A “connection” may specify a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member connects with or follows another member, the member who is connected to or following the other member may receive messages or updates (e.g., content items) in his or her personalized content stream about various activities undertaken by the other member. More specifically, the messages or updates presented in the content stream may be authored and/or published or shared by the other member, or may be automatically generated based on some activity or event involving the other member. In addition to following another member, a member may elect to follow a company, a topic, a conversation, a web page, or some other entity or object, which may or may not be included in the social graph maintained by the social networking system. With some embodiments, because the content selection algorithm selects content relating to or associated with the particular entities that a member is connected with or is following, as a member connects with and/or follows other entities, the universe of available content items for presentation to the member in his or her content stream increases. As members interact with various applications, items of content, and user interfaces of the social networking system 120, information relating to the member's activity and behavior may be stored in a database, such as the database 132.

The social networking system 120 may provide a broad range of other applications and services that allow members the opportunity to share and receive information, often customized to the interests of the member. For example, with some embodiments, the social networking system 120 may include a photo sharing application that allows members to upload and share photos with other members. With some embodiments, members of the social networking system 120 may be able to self-organize into groups, or interest groups, organized around a subject matter or topic of interest. With some embodiments, members may subscribe to or join groups affiliated with one or more companies. For instance, with some embodiments, members of the social network service may indicate an affiliation with a company at which they are employed, such that news and events pertaining to the company are automatically communicated to the members in their personalized activity or content streams. With some embodiments, members may be allowed to subscribe to receive information concerning companies other than the company with which they are employed. Membership in a group, a subscription or following relationship with a company or group, as well as an employment relationship with a company, are all examples of different types of relationships that may exist between different entities, as defined by the social graph and modeled with social graph data of the database 130.

In some example embodiments, members, on behalf of themselves or of an entity they represent (e.g., an employer or an organization), may research products or services for purchase or subscription from or via the social networking system 120. Such research may include interactions by the members with marketing output designed to promote the products or services via a marketing campaign. In some instances, as a result of interacting with items of marketing content or attending marketing activities that promote products or services, the members may purchase the products or subscribe to services (e.g., on behalf of the entities they represent). Data that describes the deal (or “transaction”) between the purchaser (e.g., the employer of one or more members) and the provider of the product or service may be stored in one or more databases associated with the social networking system 120, for example, as deal data in the database 134. The identifiers of the interactions by the members with particular items of marketing output associated with one or more marketing campaigns may be stored in one or more databases associated with the social networking system 120, for example, as member activity and behavior data in the database 132. The relationships between the members who interacted with the items of marketing output and the entity on whose behalf they performed the interactions (e.g., an employer) may be identified, for example, based on profile data stored in the database 128 or the social graph data stored in the database 130.

The application logic layer includes various application server module(s) 124, which, in conjunction with the user interface module(s) 122, generates various user interfaces with data retrieved from various data sources or data services in the data layer. With some embodiments, individual application server modules 124 are used to implement the functionality associated with various applications, services, and features of the social networking system 120. For instance, a messaging application, such as an email application, an instant messaging application, or some hybrid or variation of the two, may be implemented with one or more application server modules 124. A photo sharing application may be implemented with one or more application server modules 124. Similarly, a search engine enabling users to search for and browse member profiles may be implemented with one or more application server modules 124. Of course, other applications and services may be separately embodied in their own application server modules 124. As illustrated in FIG. 1, social networking system 120 may include the attribution system 300, which is described in more detail below.

Additionally, a third party application(s) 148, executing on a third party server(s) 146, is shown as being communicatively coupled to the social networking system 120 and the client device(s) 150. The third party server(s) 146 may support one or more features or functions on a website hosted by the third party.

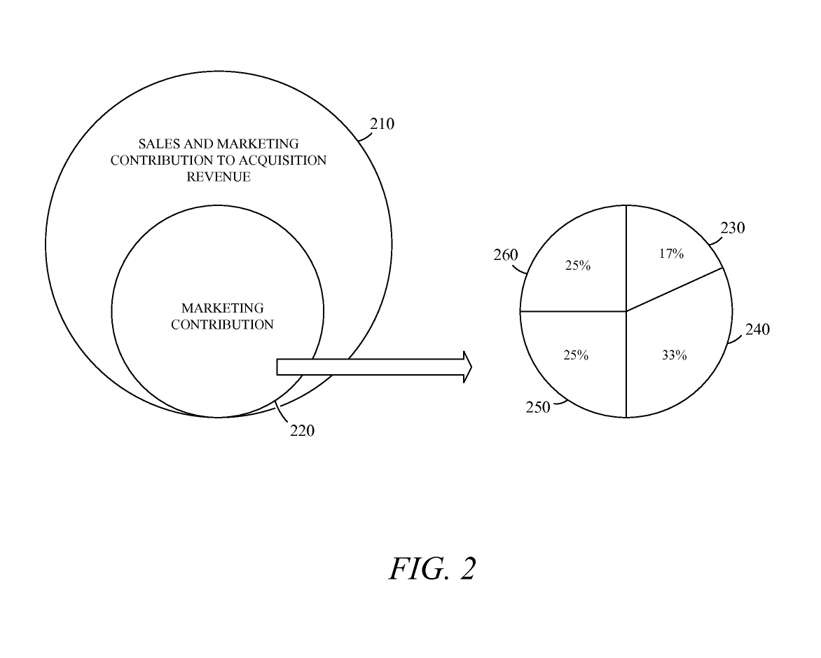

FIG. 2 is a diagram illustrating an attribution of credit for a deal among items of marketing output that contributed to the deal, according to some example embodiments. As shown in FIG. 2, item 210 represents a combination of the contributions by a sales department and by a marketing department of an organization toward closing a deal for a product or service provided by the organization. Item 220 represents a portion of the combination of contributions: the contribution by the marketing department of the organization toward the closing of the deal. In some instances, the contribution by the marketing department to the closing of the deal is measured by a percentage of the credit for the deal allocated to the marketing department. In some instances, the contribution by the marketing department to the closing of the deal is measured by a percentage of the acquisition revenue obtained as a result of closing the deal, allocated to the marketing department. The allocation of a share of the credit for the booking revenues to the marketing department may be based on the marketing output with which the purchaser or the representatives of the purchaser interacted before the date of the closing of the deal.

Additionally, FIG. 2 illustrates an example attribution of credit for the deal among four items of marketing output that were presented to the purchaser or the representatives of the purchaser when they touched the marketing campaign promoting the product or service that is the subject of the deal. Items 230, 240, 250, and 260 represent the particular shares of the credit (or revenue) allocated to the marketing department for its contribution to the closing of the deal. The shares of credit 230, 240, 250, and 260 (e.g., 17%, 33%, 25%, and 25%) correspond to particular items of marketing output associated with a marketing campaign that promotes the product or service that is the subject of the deal. The particular items of marketing output may be presented to the purchaser or the representatives of the purchaser during different touches of the marketing campaign by the purchaser or the representatives of the purchaser.

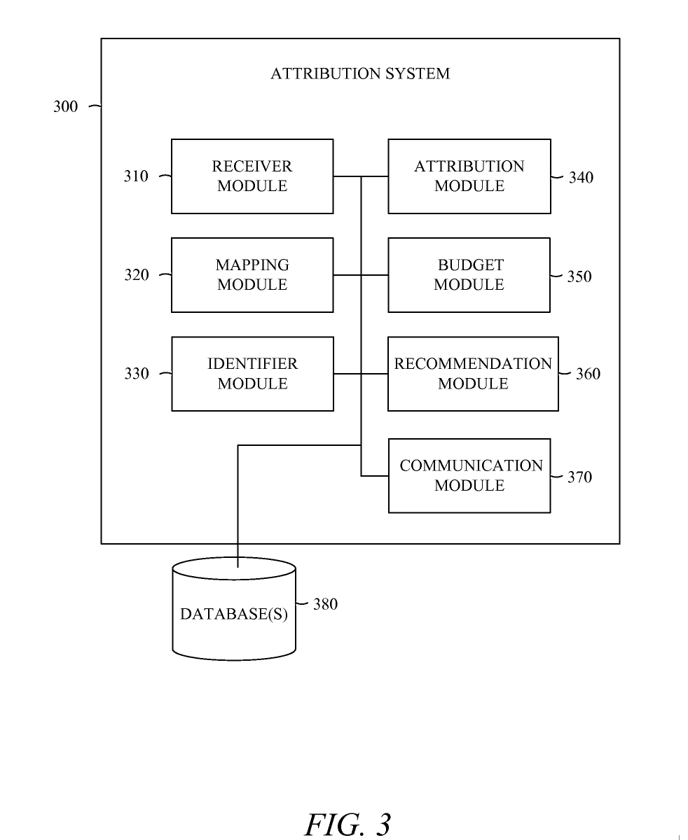

FIG. 3 is a block diagram illustrating components of the attribution system 300, according to some example embodiments. As shown in FIG. 3, the attribution system 300 may include a receiver module 310, a mapping module 320, an identifier module 330, an attribution module 340, a budget module 350, a recommendation module 360, and a communication module 370, all configured to communicate with each other (e.g., via a bus, shared memory, or a switch).

Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. In some example embodiments, any one or more of the modules described herein may comprise one or more hardware processors and may be configured to perform the operations described herein. In certain example embodiments, one or more hardware processors are configured to include any one or more of the modules described herein.

Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices. The multiple machines, databases, or devices are communicatively coupled to enable communications between the multiple machines, databases, or devices. The modules themselves are communicatively coupled (e.g., via appropriate interfaces) to each other and to various data sources, so as to allow information to be passed between the applications so as to allow the applications to share and access common data. Furthermore, the modules may access one or more databases 380 (e.g., the database 128, the database 130, the database 132, or the database 134).

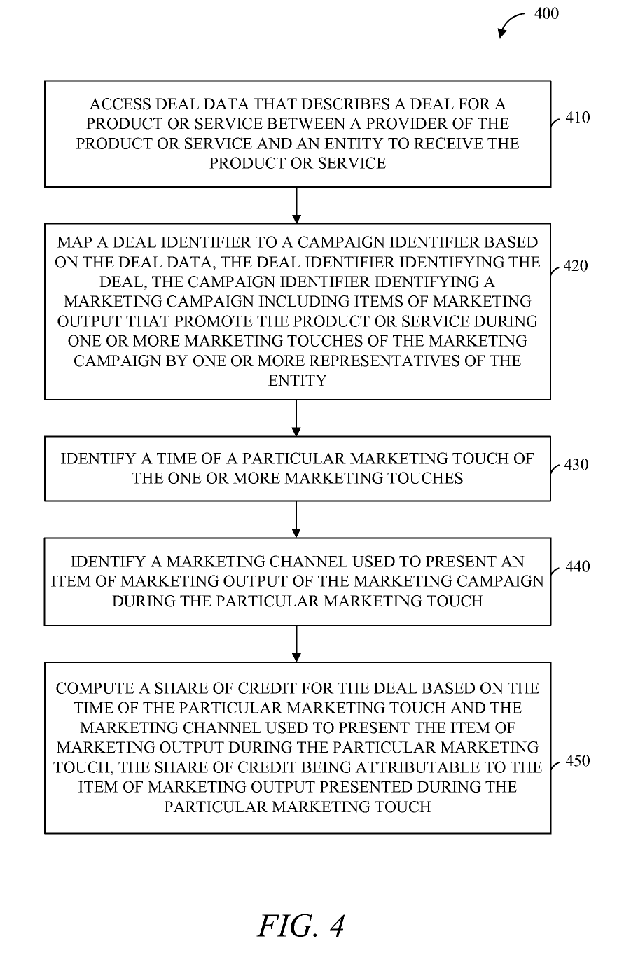

FIGS. 4-11 are flowcharts illustrating a method of attributing credit for a deal among items of marketing output that contributed to the deal, according to some example embodiments. Operations in the method 400 may be performed using modules described above with respect to FIG. 3. As shown in FIG. 4, the method 400 may include one or more of operations 410, 420, 430, 440, and 450.

At method operation 410, the receiver module 310 accesses (e.g., receives, obtains, etc.) deal data that describes a deal for a product or service. The deal (e.g., a transaction) may be entered into by a provider of the product or service and an entity (e.g., the employer of one or more members) to receive the product or service. In some instances, the deal data may include information such as a deal identifier (ID), identifiers of the parties to the deal, a description of the terms of the deal, an identifier of the product or service that is the subject of the deal, an identifier of a marketing campaign for promoting the product or service, identifiers of the items of marketing output included in the marketing campaign, a time when the parties to the deal entered the deal, etc.

At method operation 420, the mapping module 310 maps a deal identifier to a campaign identifier based on the deal data. The deal identifier may identify the deal. The campaign identifier may identify the marketing campaign that includes items of marketing output that promote the product or service during one or more marketing touches of the marketing campaign by one or more representatives of the entity (e.g., members who are employed by a particular organization). The one or more marketing touches may include one or more interactions by the one or more representatives of the entity with one or more items of marketing output created for the marketing campaign (e.g., by one or more marketing professionals).

At method operation 430, the identifier module 330 identifies the time of a particular marketing touch of the one or more marketing touches of the marketing campaign by a representatives of the entity. At method operation 440, the identifier module 330 identifies a marketing channel used to present (e.g., communicate) an item of marketing output of the marketing campaign during the particular marketing touch. The identifying of the marketing channel may be based on the member activity and behavior data stored in the database 132.

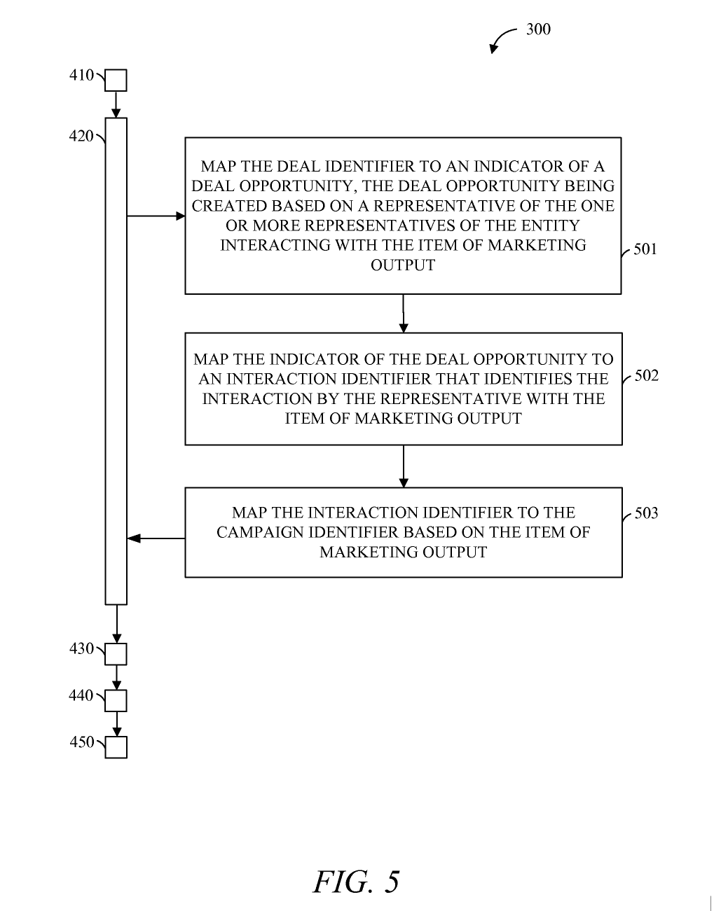

At method operation 450, the attribution module 340 computes a share of credit for the deal based on the time of the particular marketing touch and the marketing channel used to present the item of marketing output during the particular marketing touch. The share of credit may be attributable to the item of marketing output presented during the particular marketing touch. Further details with respect to the method operations of the method 400 are described below with respect to FIGS. 5-11.

As shown in FIG. 5, the method 400 may include one or more of method operations 501, 502, and 503, according to some example embodiments. Method operation 501 may be performed as part (e.g., a precursor task, a subroutine, or a portion) of method operation 420, in which the mapping module 310 maps a deal identifier to a campaign identifier based on the deal data.

At method operation 501, the mapping module 310 maps, based on the deal data, the deal identifier to an indicator of a deal opportunity. The deal opportunity (e.g., the opportunity to close a deal) may be created based on a representative of the one or more representatives of the entity interacting with the item of marketing output.

Method operation 502 may be performed after method operation 501. At method operation 502, the mapping module 310 maps the indicator of the deal opportunity to an interaction identifier that identifies the interaction by the representative of the entity with the item of marketing output (e.g., registration for a webinar or attendance of an event that promotes the product or service). The mapping of the indicator of the deal opportunity to the interaction identifier may be based on member activity and behavior data that pertains to the particular representative.

Method operation 503 may be performed after method operation 502. At method operation 503, the mapping module 310 maps the interaction identifier to the campaign identifier based on the item of marketing output (e.g., an identifier of the item of marketing output).

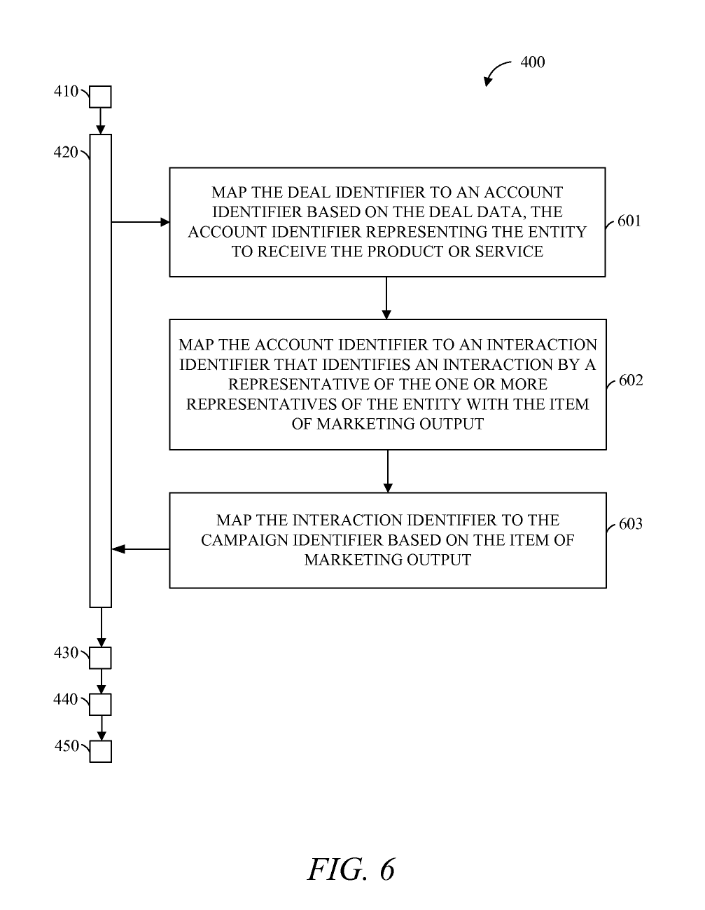

As shown in FIG. 6, the method 400 may include one or more of method operations 601, 602, and 603, according to some example embodiments. Method operation 601 may be performed as part (e.g., a precursor task, a subroutine, or a portion) of method operation 420, in which the mapping module 310 maps a deal identifier to a campaign identifier based on the deal data.

At method operation 601, the mapping module 310 maps the deal identifier to an account identifier. The mapping of the deal data to the account identifier may be based on the deal data. The account identifier may represent the entity to receive the product or service and may be stored as part of the deal data in the database 134. The account identifier may be associated with identifiers of one or more representatives of the entity who may touch the marketing campaign by interacting with items of marketing output that are included in the marketing campaign.

Method operation 602 may be performed after method operation 601. At method operation 602, the mapping module 310 maps the account identifier to an interaction identifier that identifies an interaction by a representative of the one or more representatives of the entity with the item of marketing output.

Method operation 603 may be performed after method operation 602. At method operation 603, the mapping module 310 maps the interaction identifier to the campaign identifier based on the item of marketing output (e.g., an identifier of the item of marketing output).

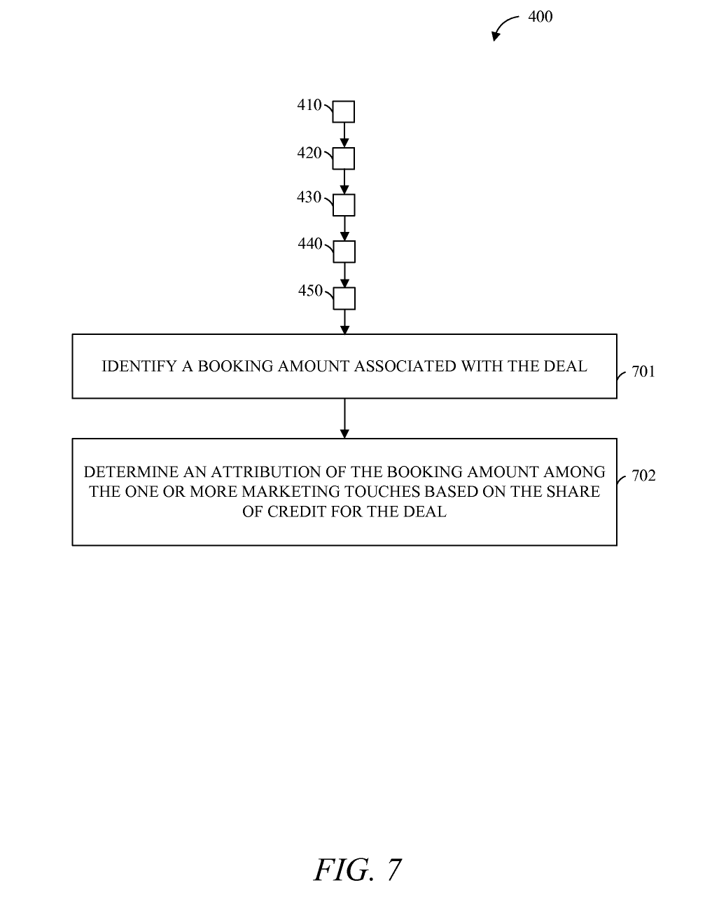

As shown in FIG. 7, the method 400 may include one or more of method operations 701 and 702, according to some example embodiments. Method operation 701 may be performed after method operation 450, in which the attribution module 340 computes a share of credit for the deal based on the time of the particular marketing touch and the marketing channel used to present the item of marketing output during the particular marketing touch. At method operation 701, the attribution module 340 identifies a booking amount associated with the deal.

Method operation 702 may be performed after method operation 701. At method operation 702, the attribution module 340 determines an attribution of the booking amount among the one or more marketing touches based on the share of credit for the deal. For example, the attribution module 340 may compute a first share of credit attributable to a first marketing input (e.g., a webinar) associated with a marketing campaign touched by a first representative of the entity (e.g., through registration for the webinar) to be 45% of the entire credit for the deal. The attribution module 340 may compute a second share of credit attributable to a second marketing input (e.g., a conference for promoting the product or service) associated with a marketing campaign touched by a first representative of the entity (e.g., through attendance of the conference) to be 55% of the entire credit for the deal. The attribution module 340 may identify that the booking amount associated with the deal between the provider of the product or service and the entity receiving the product or service (and represented by the first and second representatives) is $1000. Then the attribution module 340 may determine that $450 of the $1000 is attributable to the first marketing touch (e.g., the registration by the first representative for the webinar) and $550 of the $1000 is attributable to the second marketing touch (e.g., the attendance of the conference by the second representative).

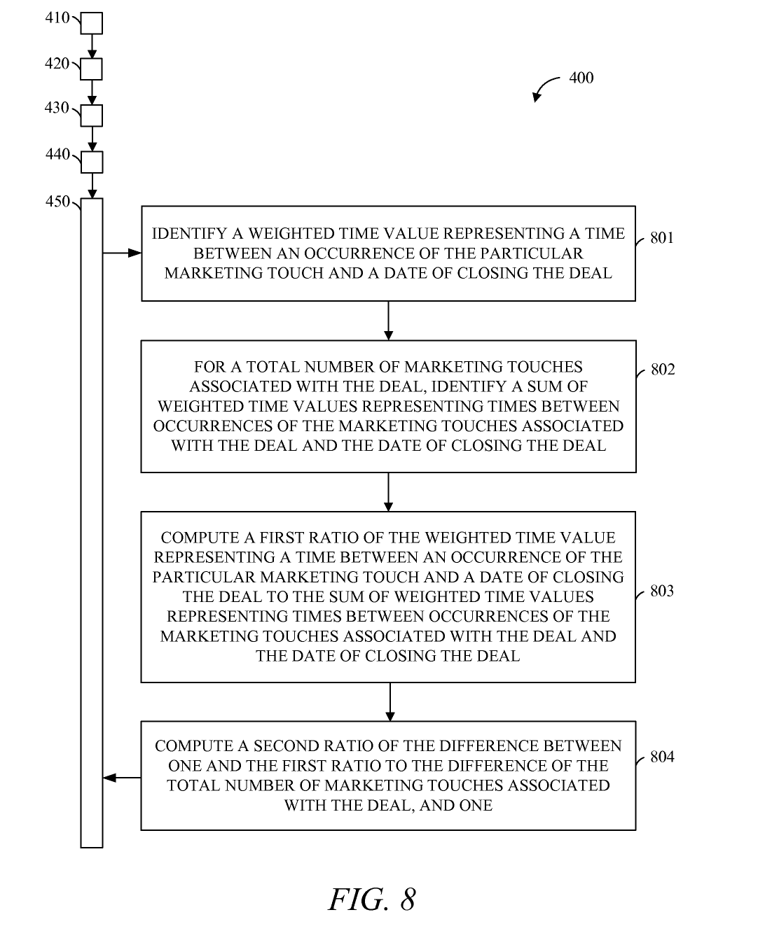

As shown in FIG. 8, the method 400 may include method operations 801, 802, 803, and 804, according to some example embodiments. Method operation 801 may be performed as part (e.g., a precursor task, a subroutine, or a portion) of method operation 450, in which the attribution module 340 computes a share of credit for the deal based on the time of the particular marketing touch and the marketing channel used to present the item of marketing output during the particular marketing touch. At method operation 801, the attribution module 340 identifies a weighted time value representing a time between an occurrence of the particular marketing touch and a date of closing the deal.

Method operation 802 may be performed after method operation 801. At method operation 802, the attribution module 340 identifies, for a total number of marketing touches associated with the deal, a sum of weighted time values representing times between occurrences of the marketing touches associated with the deal and the date of closing the deal.

Method operation 803 may be performed after method operation 802. At method operation 803, the attribution module 340 computes a first ratio of the weighted time value representing a time between the occurrence of the particular marketing touch and the date of closing the deal to the sum of weighted time values representing times between occurrences of the marketing touches associated with the deal and the date of closing the deal.

Method operation 804 may be performed after method operation 803. At method operation 804, the attribution module 340 computes a second ratio of the difference between one and the first ratio to the difference of the total number of marketing touches associated with the deal, and one.

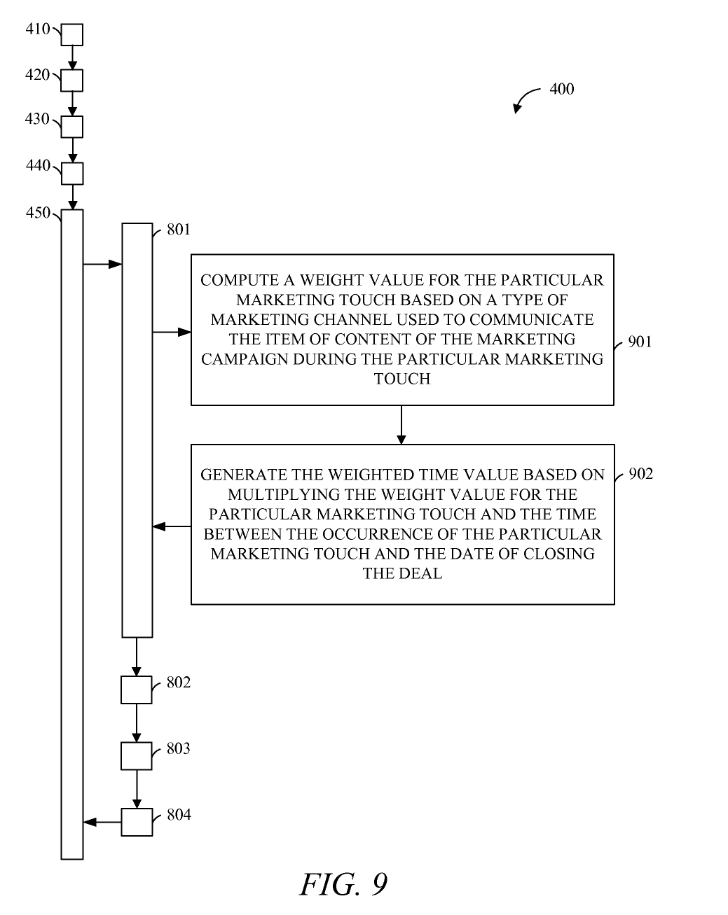

As shown in FIG. 9, the method 400 may include one or more method operations 901 and 902, according to some example embodiments. Method operation 901 may be performed as part (e.g., a precursor task, a subroutine, or a portion) of method operation 801, in which the attribution module 340 identifies a weighted time value representing a time between an occurrence of the particular marketing touch and a date of closing the deal. At method operation 901, the attribution module 340 computes a weight value for the particular marketing touch based on a type of marketing channel used to present the item of marketing output during the particular marketing touch.

Method operation 902 may be performed as part (e.g., a precursor task, a subroutine, or a portion) of method operation 801 after method operation 901. At method operation 902, the attribution module 340 generates the weighted time value based on multiplying the weight value for the particular marketing touch and the time between the occurrence of the particular marketing touch and the date of closing the deal.

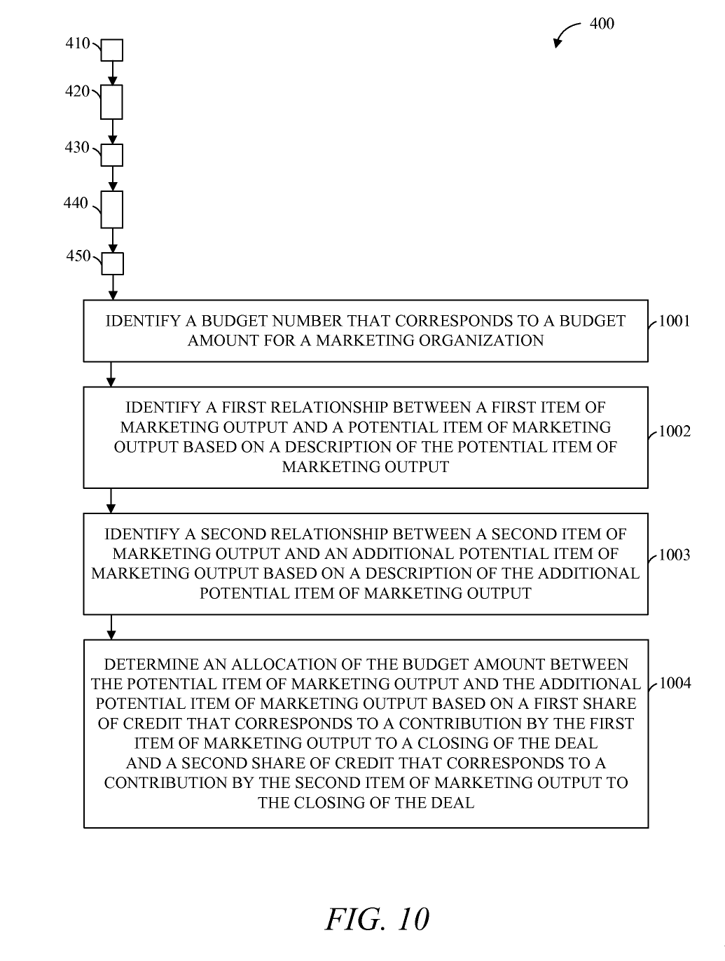

As shown in FIG. 10, the method 400 may include one or more method operations 1001, 1002, 1003, and 1004, according to some example embodiments. Method operation 1001 may be performed after method operation 450, in which the attribution module 340 computes a share of credit for the deal based on the time of the particular marketing touch and the marketing channel used to present the item of marketing output during the particular marketing touch. In some example embodiments, the item of marketing output may be a first item of marketing output. The share of credit may be a first share of credit (e.g., a first percentage) that corresponds to a contribution by the first item of marketing output to a closing of the deal. At method operation 1001, the budget module 350 identifies a budget number that corresponds to a budget amount for a marketing organization.

Method operation 1002 may be performed after method operation 1001. At method operation 1002, the budget module 350 identifies a first relationship between the first item of marketing output and a potential item of marketing output based on a description of the potential item of marketing output. The first relationship may be based on the first item of marketing output and the potential item of marketing output having a common attribute (e.g., are of a particular type, belong to a particular category, etc.).

Method operation 1003 may be performed after method operation 1002. At method operation 1003, the budget module 350 identifies a second relationship between the second item of marketing output and an additional potential item of marketing output based on a description of the additional potential item of marketing output. The second relationship may be based on the second item of marketing output and the additional potential item of marketing output having a common attribute (e.g., are of a particular type, belong to a particular category, etc.).

Method operation 1004 may be performed after method operation 1003. At method operation 1004, the budget module 350 determines an allocation of the budget amount between the potential item of marketing output and the additional potential item of marketing output. The allocation of the budget may be based on the first share of credit that corresponds to a contribution by the first item of marketing output to the closing of the deal and a second share of credit that corresponds to a contribution by the second item of marketing output to the closing of the deal.

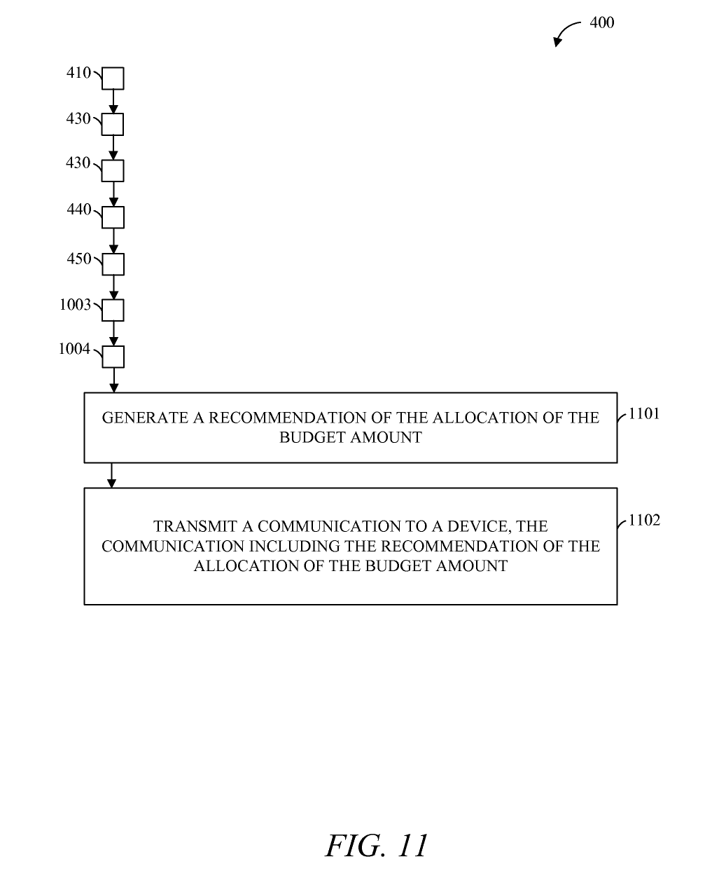

As shown in FIG. 11, the method 400 may include one or more method operations 1101 and 1102, according to some example embodiments. Method operation 1101 may be performed after method operation 1004, in which the budget module 350 determines an allocation of the budget amount between the potential item of marketing output and the additional potential item of marketing output. At method operation 1101, the recommendation module 360 generates a recommendation of the allocation of the budget amount.

Method operation 1102 may be performed after method operation 1101. At method operation 1102, the communication 370 transmits a communication to a device (e.g., the client device 150). The communication may include the recommendation of the allocation of the budget amount.

### Example Mobile Device

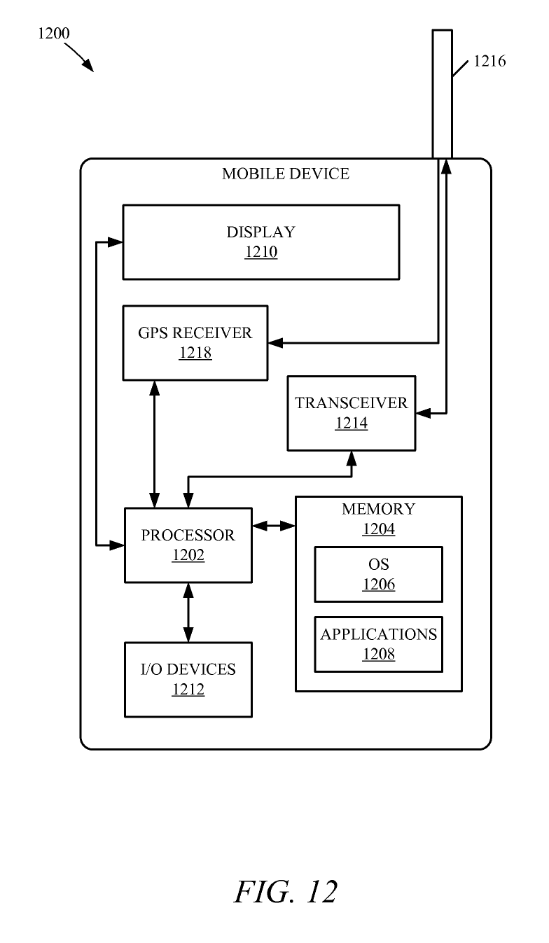

FIG. 12 is a block diagram illustrating a mobile device 1200, according to an example embodiment. The mobile device 1200 may include a processor 1202. The processor 1202 may be any of a variety of different types of commercially available processors 1202 suitable for mobile devices 1200 (for example, an XScale architecture microprocessor, a microprocessor without interlocked pipeline stages (MIPS) architecture processor, or another type of processor 1202). A memory 1204, such as a random access memory (RAM), a flash memory, or other type of memory, is typically accessible to the processor 1202. The memory 1204 may be adapted to store an operating system (OS) 1206, as well as application programs 1208, such as a mobile location enabled application that may provide LBSs to a user. The processor 1202 may be coupled, either directly or via appropriate intermediary hardware, to a display 1210 and to one or more input/output (I/O) devices 1212, such as a keypad, a touch panel sensor, a microphone, and the like. Similarly, in some embodiments, the processor 1202 may be coupled to a transceiver 1214 that interfaces with an antenna 1216. The transceiver 1214 may be configured to both transmit and receive cellular network signals, wireless data signals, or other types of signals via the antenna 1216, depending on the nature of the mobile device 1200. Further, in some configurations, a GPS receiver 1218 may also make use of the antenna 1216 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors or processor-implemented modules, not only residing within a single machine, but deployed across a number of machines. In some example embodiments, the one or more processors or processor-implemented modules may be located in a single location (e.g., within a home environment, an office environment or as a server farm), while in other embodiments the one or more processors or processor-implemented modules may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

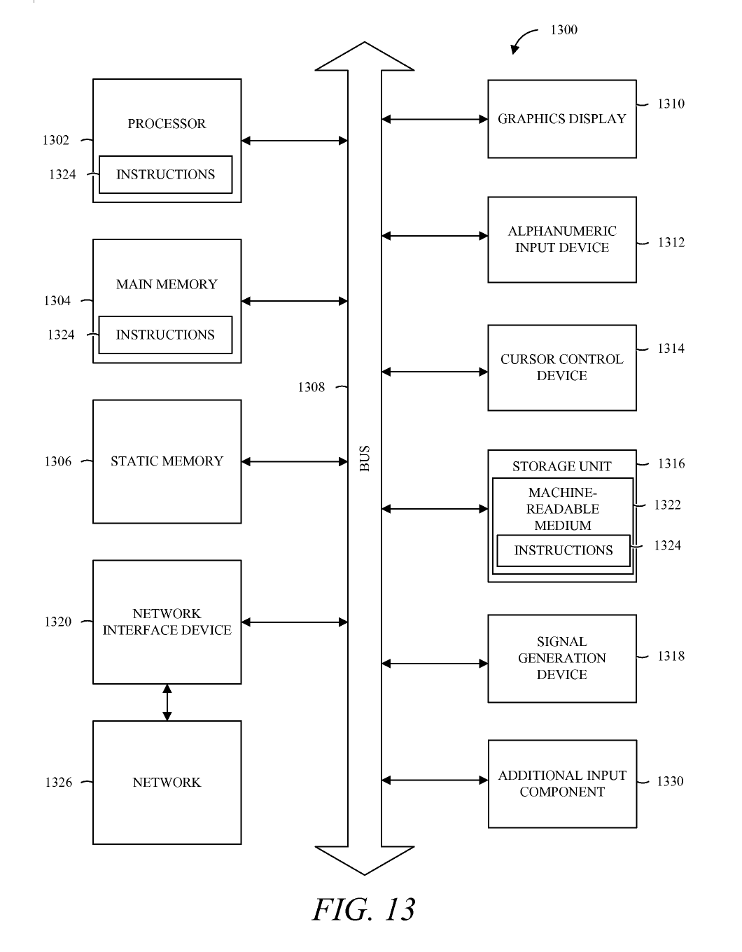

FIG. 13 is a block diagram illustrating components of a machine 1300, according to some example embodiments, able to read instructions 1324 from a machine-readable medium 1322 (e.g., a non-transitory machine-readable medium, a machine-readable storage medium, a computer-readable storage medium, or any suitable combination thereof) and perform any one or more of the methodologies discussed herein, in whole or in part. Specifically, FIG. 13 shows the machine 1300 in the example form of a computer system (e.g., a computer) within which the instructions 1324 (e.g., software, a program, an application, an applet, an app, or other executable code) for causing the machine 1300 to perform any one or more of the methodologies discussed herein may be executed, in whole or in part.

In alternative embodiments, the machine 1300 operates as a standalone device or may be connected (e.g., networked) to other machines. In a networked deployment, the machine 1300 may operate in the capacity of a server machine or a client machine in a server-client network environment, or as a peer machine in a distributed (e.g., peer-to-peer) network environment. The machine 1300 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1324, sequentially or otherwise, that specify actions to be taken by that machine. Further, while only a single machine is illustrated, the term “machine” shall also be taken to include any collection of machines that individually or jointly execute the instructions 1324 to perform all or part of any one or more of the methodologies discussed herein.

The machine 1300 includes a processor 1302 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1304, and a static memory 1306, which are configured to communicate with each other via a bus 1308. The processor 1302 may contain microcircuits that are configurable, temporarily or permanently, by some or all of the instructions 1324 such that the processor 1302 is configurable to perform any one or more of the methodologies described herein, in whole or in part. For example, a set of one or more microcircuits of the processor 1302 may be configurable to execute one or more modules (e.g., software modules) described herein.

The machine 1300 may further include a graphics display 1310 (e.g., a plasma display panel (PDP), a light emitting diode (LED) display, a liquid crystal display (LCD), a projector, a cathode ray tube (CRT), or any other display capable of displaying graphics or video). The machine 1300 may also include an alphanumeric input device 1312 (e.g., a keyboard or keypad), a cursor control device 1314 (e.g., a mouse, a touchpad, a trackball, a joystick, a motion sensor, an eye tracking device, or other pointing instrument), a storage unit 1316, an audio generation device 1318 (e.g., a sound card, an amplifier, a speaker, a headphone jack, or any suitable combination thereof), and a network interface device 1320.

The storage unit 1316 includes the machine-readable medium 1322 (e.g., a tangible and non-transitory machine-readable storage medium) on which are stored the instructions 1324 embodying any one or more of the methodologies or functions described herein. The instructions 1324 may also reside, completely or at least partially, within the main memory 1304, within the processor 1302 (e.g., within the processor's cache memory), or both, before or during execution thereof by the machine 1300. Accordingly, the main memory 1304 and the processor 1302 may be considered machine-readable media (e.g., tangible and non-transitory machine-readable media). The instructions 1324 may be transmitted or received over the network 1326 via the network interface device 1320. For example, the network interface device 1320 may communicate the instructions 1324 using any one or more transfer protocols (e.g., hypertext transfer protocol (HTTP)).

In some example embodiments, the machine 1300 may be a portable computing device, such as a smart phone or tablet computer, and have one or more additional input components 1330 (e.g., sensors or gauges). Examples of such input components 1330 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1322 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 1324 for execution by the machine 1300, such that the instructions 1324, when executed by one or more processors of the machine 1300 (e.g., processor 1302), cause the machine 1300 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method, comprising:
accessing deal data that describes a deal for a product or service, the deal entered into by a provider of the product or service and an entity to receive the product or service;
mapping, by a machine including a memory and at least one hardware processor, a deal identifier to a campaign identifier based on the deal data, the deal identifier identifying the deal, the campaign identifier identifying a marketing campaign including items of marketing output that promote the product or service during one or more marketing touches of the marketing campaign by one or more representatives of the entity;
identifying a time of a particular marketing touch of the one or more marketing touches;
identifying a marketing channel used to present an item of marketing output of the marketing campaign during the particular marketing touch; and
computing a share of credit for the deal based on the time of the particular marketing touch and the marketing channel used to present the item of marketing output during the particular marketing touch, the share of credit being attributable to the item of marketing output presented during the particular marketing touch.

2. The method of claim 1, wherein the one or more marketing touches include one or more interactions by the one or more representatives of the entity with one or more items of marketing output created for the marketing campaign.

3. The method of claim 1, wherein the mapping of the deal identifier to the campaign identifier includes:
mapping the deal identifier to an indicator of a deal opportunity, the deal opportunity being created based on a representative of the one or more representatives of the entity interacting with the item of marketing output;
mapping the indicator of the deal opportunity to an interaction identifier that identifies the interaction by the representative with the item of marketing output; and
mapping the interaction identifier to the campaign identifier based on the item of marketing output.

4. The method of claim 1, wherein the mapping of the deal identifier to the campaign identifier includes:
mapping the deal identifier to an account identifier based on the deal data, the account identifier representing the entity to receive the product or service;
mapping the account identifier to an interaction identifier that identifies an interaction by a representative of the one or more representatives of the entity with the item of marketing output; and
mapping the interaction identifier to the campaign identifier based on the item of marketing output.

5. The method of claim 1, further comprising:
identifying, based on the deal data, a booking amount associated with the deal; and
determining an attribution of the booking amount among the one or more marketing touches based on the share of credit for the deal.

6. The method of claim 1, wherein the computing of the share of credit attributable to the item of marketing output presented during the particular marketing touch includes:
identifying a weighted time value representing a time between an occurrence of the particular marketing touch and a date of closing the deal;
for a total number of marketing touches associated with the deal, identifying a sum of weighted time values representing times between occurrences of the marketing touches associated with the deal and the date of closing the deal;
computing a first ratio of the weighted time value to the sum of weighted time values representing times between occurrences of the marketing touches associated with the deal and the date of closing the deal; and
computing a second ratio of the difference between one and the first ratio to the difference of the total number of marketing touches associated with the deal, and one.

7. The method of claim 6, wherein the identifying of the weighted time value representing a time between an occurrence of the particular marketing touch and a date of closing the deal includes:
computing a weight value for the particular marketing touch based on a type of marketing channel used to present the item of marketing output during the particular marketing touch; and
generating the weighted time value based on multiplying the weight value for the particular marketing touch and the time between the occurrence of the particular marketing touch and the date of closing the deal.

8. The method of claim 1, wherein the item of marketing output is a first item of marketing output and the share of credit is a first share of credit that corresponds to a contribution by the first item of marketing output to a closing of the deal, the method further comprising:
identifying a budget number that corresponds to a budget amount for a marketing organization;
identifying a first relationship between the first item of marketing output and a potential item of marketing output based on a description of the potential item of marketing output;
identifying a second relationship between the second item of marketing output and an additional potential item of marketing output based on a description of the additional potential item of marketing output; and
determining an allocation of the budget amount between the potential item of marketing output and the additional potential item of marketing output based on the first share of credit and a second share of credit that corresponds to a contribution by the second item of marketing output to the closing of the deal.

9. The method of claim 8, further comprising:
generating a recommendation of the allocation of the budget amount; and
transmitting a communication to a device, the communication including the recommendation of the allocation of the budget amount.

10. A system, comprising:
a receiver module configured to access deal data that describes a deal for a product or service, the deal entered into by a provider of the product or service and an entity to receive the product or service;
a mapping module, comprising one or more hardware processors, configured to map, based on the deal data, a deal identifier to a campaign identifier based on the deal data, the deal identifier identifying the deal, the campaign identifier identifying a marketing campaign including items of marketing output that promote the product or service during one or more marketing touches of the marketing campaign by one or more representatives of the entity;
an identifier module configured to:
identify a time of a particular marketing touch of the one or more marketing touches and
identify a marketing channel used to present an item of marketing output of the marketing campaign during the particular marketing touch; and
an attribution module configured to compute a share of credit for the deal based on the time of the particular marketing touch and the marketing channel used to present the item of marketing output during the particular marketing touch, the share of credit being attributable to the item of marketing output presented during the particular marketing touch.

11. The system of claim 10, wherein the one or more marketing touches include one or more interactions by the one or more representatives of the entity with one or more items of marketing output created for the marketing campaign.

12. The system of claim 10, wherein the mapping of the deal identifier to the campaign identifier includes:
mapping the deal identifier to an indicator of a deal opportunity, the deal opportunity being created based on a representative of the one or more representatives of the entity interacting with the item of marketing output;
mapping the indicator of the deal opportunity to an interaction identifier that identifies the interaction by the representative with the item of marketing output; and
mapping the interaction identifier to the campaign identifier based on the item of marketing output.

13. The system of claim 10, wherein the mapping of the deal identifier to the campaign identifier includes:
mapping the deal identifier to an account identifier based on the deal data, the account identifier representing the entity to receive the product or service;
mapping the account identifier to an interaction identifier that identifies an interaction by a representative of the one or more representatives of the entity with the item of marketing output; and
mapping the interaction identifier to the campaign identifier based on the item of marketing output.

14. The system of claim 10, wherein the attribution module is further configured to:
identify, based on the deal data, a booking amount associated with the deal and
determine an attribution of the booking amount among the one or more marketing touches based on the share of credit for the deal.

15. The system of claim 10, wherein the computing of the share of credit attributable to the item of marketing output presented during the particular marketing touch includes:
identifying a weighted time value representing a time between an occurrence of the particular marketing touch and a date of closing the deal;
for a total number of marketing touches associated with the deal, identifying a sum of weighted time values representing times between occurrences of the marketing touches associated with the deal and the date of closing the deal;
computing a first ratio of the weighted time value to the sum of weighted time values representing times between occurrences of the marketing touches associated with the deal and the date of closing the deal; and
computing a second ratio of the difference between one and the first ratio to the difference of the total number of marketing touches associated with the deal, and one.

16. The system of claim 15, wherein the identifying of the weighted time value representing a time between an occurrence of the particular marketing touch and a date of closing the deal includes:
computing a weight value for the particular marketing touch based on a type of marketing channel used to present the item of marketing output during the particular marketing touch; and
generating the weighted time value based on multiplying the weight value for the particular marketing touch and the time between the occurrence of the particular marketing touch and the date of closing the deal.

17. The system of claim 10, wherein the item of marketing output is a first item of marketing output and the share of credit is a first share of credit that corresponds to a contribution by the first item of marketing output to a closing of the deal, further comprising:
a budget module configured to
identify a budget number that corresponds to a budget amount for a marketing organization,
identify a first relationship between the first item of marketing output and a potential item of marketing output based on a description of the potential item of marketing output,
identifying a second relationship between the second item of marketing output and an additional potential item of marketing output based on a description of the additional potential item of marketing output, and
determine an allocation of the budget amount between the potential item of marketing output and the additional potential item of marketing output based on the first share of credit and the second share of credit that corresponds to a contribution by the second item of marketing output to the closing of the deal.

18. The system of claim 17, further comprising:
a recommendation module configured to generate a recommendation of the allocation of the budget amount; and
a communication module configured to transmit a communication to a device, the communication including the recommendation of the allocation of the budget amount.

19. A non-transitory machine-readable medium comprising instructions that, when executed by one or more processors of a machine, cause the machine to perform operations comprising:
accessing deal data that describes a deal for a product or service, the deal entered into by a provider of the product or service and an entity to receive the product or service;
mapping a deal identifier to a campaign identifier based on the deal data, the deal identifier identifying the deal, the campaign identifier identifying a marketing campaign including items of marketing output that promote the product or service during one or more marketing touches of the marketing campaign by one or more representatives of the entity;
identifying a time of a particular marketing touch of the one or more marketing touches;
identifying a marketing channel used to present an item of marketing output of the marketing campaign during the particular marketing touch; and
computing a share of credit for the deal based on the time of the particular marketing touch and the marketing channel used to present the item of marketing output during the particular marketing touch, the share of credit being attributable to the item of marketing output presented during the particular marketing touch.

20. The non-transitory machine readable storage medium of claim 19, wherein the operations further comprise:
identifying, based on the deal data, a booking amount associated with the deal; and
determining an allocation of the booking amount among the one or more marketing touches based on the share of credit for the deal.
